(19) United States
(12) Patent Application Publication
(10) Pub. No.: US 2014/0168853 A1
(43) Pub. Date: Jun. 19, 2014

(54) SUPER CAPACITOR AND METHOD OF MANUFACTURING THE SAME

(71) Applicant: SAMSUNG ELECTRO-MECHANICS CO., LTD., Gyeonggi-do (KR)

(72) Inventors: Jae Hoon Choi, Gyeonggi-do (KR); Yeong Su Cho, Gyeonggi-do (KR); Eun Sil Kim, Gyeonggi-do (KR); Se Woong Paeng, Gyeonggi-do (KR); Bae Kyun Kim, Gyeonggi-do (KR); Ji Sung Cho, Gyeonggi-do (KR)

(73) Assignee: SAMSUNG ELECTRO-MECHANICS CO., LTD., Gyeonggi-do (KR)

(21) Appl. No.: 13/842,189

(22) Filed: Mar. 15, 2013

(30) Foreign Application Priority Data
Dec. 14, 2012 (KR) 10-2012-0146430

(51) Int. Cl. H01G 11/26; H01G 9/00; H01G 13/00

(52) U.S. Cl. CPC H01G 11/26; H01G 13/00; H01G 9/0029
USPC 361/502; 29/25.03

(57) ABSTRACT

Disclosed herein is a super capacitor including: an electrode assembly; a pouch cell enclosing an outer peripheral surface of the electrode assembly; a resin case molding the pouch cell; and a lead wire of which one side is electrically connected to the electrode assembly and the other side exposed to the outside of the resin case is bonded to an outer peripheral surface of the resin case. According to the present invention, the super capacitor may have durability against external impact, and cycle life characteristics of the super capacitor may be significantly improved.

### CROSS REFERENCE(S) TO RELATED APPLICATIONS

This application claims the benefit under 35 U.S.C. Section 119 of Korean Patent Application Serial No. 10-2012-0146430, entitled “Super Capacitor and Method of Manufacturing the Same” filed on Dec. 14, 2012, which is hereby incorporated by reference in its entirety into this application.

### BACKGROUND OF THE INVENTION

1. Technical Field

The present invention relates to a super capacitor and a method of manufacturing the same, and more particularly, to a packaged super capacitor and a method of manufacturing the same.

2. Description of the Related Art

Generally, a high performance portable power source is a core component of a finished product essentially used in all of the portable information communication devices, electronic devices, an electric automobile, or the like. All of the recently developed next generation energy storage systems use electrochemical principles, and among them, a lithium (Li) based secondary battery and an electrochemical capacitor are representative.

Among them, the electrochemical capacitor, which is a energy storage device storing and supplying electric energy using capacitor behavior caused by electrochemical reactions between electrodes and electrolytes, has energy density and output density significantly higher as compared with the existing electrolytic capacitor and secondary battery, respectively, such that the electrochemical capacitor has been spotlighted as a new conceptual energy storage power source capable of rapidly storing or supplying a large amount of energy. The electrochemical capacitor is expected to be variously used as a back-up power source of electronic devices, a pulse power source of portable communication devices, a high-output power source of a hybrid electric automobile due to its characteristics that the electrochemical capacitor may supply a large amount of current within a short time.

Among the electrochemical capacitors as described above, a super capacitor having energy density higher than that of the existing capacitor has been mainly developed. An electrical double layer capacitor (EDLC) using the principle of an electric double layer generated between the electrode, a pseudo-capacitor generated by a faradaic reaction including movement of electric charges between the electrode and the electrolyte such as an absorption reaction of ions in the electrolyte on an electrode surface, a reduction/oxidation reaction of the electrode, or the like, and a hybrid capacitor having an asymmetric electrode shape are representative super capacitors.

A basic structure of the super capacitor will be described below with reference to Korean Patent Laid-open Publication No. 10-2012-0056556 (hereinafter, referred to as Patent Document 1). A cathode plate and an anode plate that are configured of a current collector and an active material layer are coupled to each other, having a separator therebetween, and after a capacitor configured of the cathode plate/the separator/the anode plate is received in a can made of a metal material and having a cylindrical or prismatic shape or a pouch made of a laminate film, an electrolyte solution is injected thereinto, thereby manufacturing a final capacitor.

In the existing super capacitor having a configuration as described above, electricity may be charged by the principle of electrochemical mechanism that when a voltage having a several volts is applied to a current collector to which both terminals of the electrode are connected, an electric field is formed, such that ions in the electrolyte move and are absorbed by electrode surfaces, thereby storing electricity.

However, in the case of using a can made of the metal material, it may be difficult to manufacture the super capacitor by applying an outer-case having a shape in which the super capacitor may be directly mounted on a circuit board using a surface mount technology (SMT) method, and in the case of using a laminate pouch film to sealing the case, since strength of the outer case may be weak, when the outer case is damaged or hit by a sharp tool, or the like, a problem in the stability may be generated, such that reliability of a cell may be deteriorated.

In addition, as a charging/discharging cycle of the super capacitor is performed, gas is generated therein, resistance is increased by a swelling phenomenon that adhesive force between the cathode plate/the separator/the anode plate is reduced, and cycle life characteristics may be deteriorated.

Further, the super capacitor includes a liquid electrolyte. In the case in which any heat radiating means for a gasket is not provided as in the related art, the sealing of the outer case may become weak at the time of operation at a high temperature, the electrolyte solution may be leaked, or external moisture is infiltrated into the case, such that characteristics of the super capacitor may be deteriorated.

### RELATED ART DOCUMENT

### Patent Document

(Patent Document 1) Korean Patent Laid-open Publication No. 10-2012-0056556

### SUMMARY OF THE INVENTION

An object of the present invention is to provide to a super capacitor capable of improving cycle life characteristics, durability, and stability by radiating heat generated therein, having resistance against a swelling phenomenon, and suppressing an outer case from being damaged from the outside, and a method of manufacturing the same.

According to an exemplary embodiment of the present invention, there is provided a super capacitor including: an electrode assembly; a pouch cell enclosing an outer peripheral surface of the electrode assembly; a resin case molding the pouch cell; and a lead wire of which one side is electrically connected to the electrode assembly and the other side exposed to the outside of the resin case is bonded to an outer peripheral surface of the resin case.

At least one surface of the resin case may be provided with a hole, and a surface of the pouch cell may be partially exposed to the outside through the hole.

A metal material may be filled in the hole.

The number of holes formed in one surface of the resin case may be one or more.

Both sides of the electrode assembly may be formed with electrode taps, and the electrode tap may be exposed to the outside of the pouch cell to thereby be connected to the one side of the lead wire.

An electrode solution may be interposed in the pouch cell.

A distal end of the lead wire exposed to the outside of the resin case may be extended up to a mounting surface of the resin case.

The electrode assembly may be configured of at least one of an anode plate and a cathode plate that are alternately stacked, and a separator interposed between the anode plate and the cathode plate.

The pouch cell may be made of a laminate film configured of at least one metal thin plate and polymer resin layers stacked on both surfaces of the metal thin plate.

According to another exemplary embodiment of the present invention, there is provided a method of manufacturing a super capacitor, the method including: preparing an electrode assembly including electrode taps protruding at both sides thereof; forming a pouch cell on an outer peripheral surface of the electrode assembly, injecting an electrode solution into the pouch cell, and then sealing the pouch cell; welding the electrode tap exposed to the outside of the pouch cell to one side of a lead wire; molding the pouch cell into a resin case; and bending the lead wire exposed to the outside of the resin case along an outer peripheral surface of the resin case.

In the molding of the pouch cell into a resin case, a forming mold may be designed so that a hole is present in at least one surface of the resin case to thereby partially expose a surface of the pouch cell to the outside through the hole.

The method may further include, after the molding of the pouch cell into a resin case, performing a hole forming process on at least one surface of the resin case to thereby partially expose a surface of the pouch cell to the outside through the hole.

The method of manufacturing a super capacitor as described above may further include filling a metal material in the hole.

### BRIEF DESCRIPTION OF THE DRAWINGS

FIG. 1 is a cross-sectional view of a super capacitor according to an exemplary embodiment of the present invention;

FIG. 2 is an enlarged cross-sectional view of a portion of a pouch cell included in the super capacitor according to the exemplary embodiment of the present invention;

FIG. 3 is a plane view of a super capacitor according to the exemplary embodiment of the present invention;

FIG. 4 is a view for describing a form in which a metal material is filled in a hole;

FIG. 5 is a view for describing a configuration example of the hole; and

FIGS. 6 to 10 are process views sequentially showing a method of manufacturing a super capacitor according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

FIG. 1 is a cross-sectional view of a super capacitor according to an exemplary embodiment of the present invention. Further, the components shown in the drawings are not necessarily drawn according to the reduced scale. For example, in order to help the understanding of the present invention, some components shown in the drawings may be exaggerated as compared with other components.

Referring to FIG. 1, the super capacitor 100 according to the exemplary embodiment of the present invention may be configured to include an electrode assembly 110, a pouch cell 120 enclosing an outer peripheral surface of the electrode assembly 110, a resin case 130 molding the pouch cell 120, and a lead wire 140 electrically connected to the electrode assembly 110 through electrode taps 111 protruding from left and right side portions of the electrode assembly 110.

Here, the electrode assembly 110 may be configured of at least one of an anode plate and a cathode plate that are alternately stacked, and a separator interposed between the anode plate and the cathode plate. However, for convenience of explanation, the anode plate/the separator/the cathode plate are not separately represented, but comprehensively represented as a single electrode assembly 110.

More specifically, each of the anode plate and the cathode plate may be configured of a current collector and the active material layer applied on one surface of the current collector, and the electrode tap 111 extended from the current collector is exposed to the outside of the pouch cell 120 to thereby be connected to one side of the lead wire 140.

The lead wire 140 exposed to the outside of the resin case 130 may be bonded to an outer peripheral surface of the resin case 130. Therefore, the lead wire 140 may be appropriately bent according to a shape of the resin case 130.

The lead wire 140 is formed at a predetermined length or more, such that a distal end 140a of the lead wire 140 may be bonded to a mounting surface of the resin case 130, that is, the outer peripheral surface of the resin case 130 (a bottom case of the resin case 130 in FIG. 1) bonded to a substrate when the resin case 130 is mounted on the substrate. Therefore, the super capacitor according to the exemplary embodiment of the present invention may be easily surface-mounted, and a total thickness of the super capacitor may be reduced, such that a required thickness value (for example, 1.5 mm or less) may be easily satisfied.

Meanwhile, a liquid electrolyte, that is, an electrolyte solution is interposed in the pouch cell 120, such that an electric field is formed when voltage is applied from the outside through the lead wire 140. Therefore, ions in the electrolyte move to thereby be absorbed on a surface of the electrode assembly 110 (more specifically, the active material layer), such that electricity is charged. Here, the electrolyte solution may be prepared by dissolving ammonium based electrolyte salts, lithium based electrolyte salt, or a mixture thereof in one solvent of propylene carbonate (PC), acetonitrile (AN), ethylene carbonate (EC), ethylmethyl carbonate (EMC), dimethyl carbonate (DMC), diethyl carbonate (DEC), sulfolane, γ-butyrolactone (GBL), or the like, or a mixture solvent thereof.

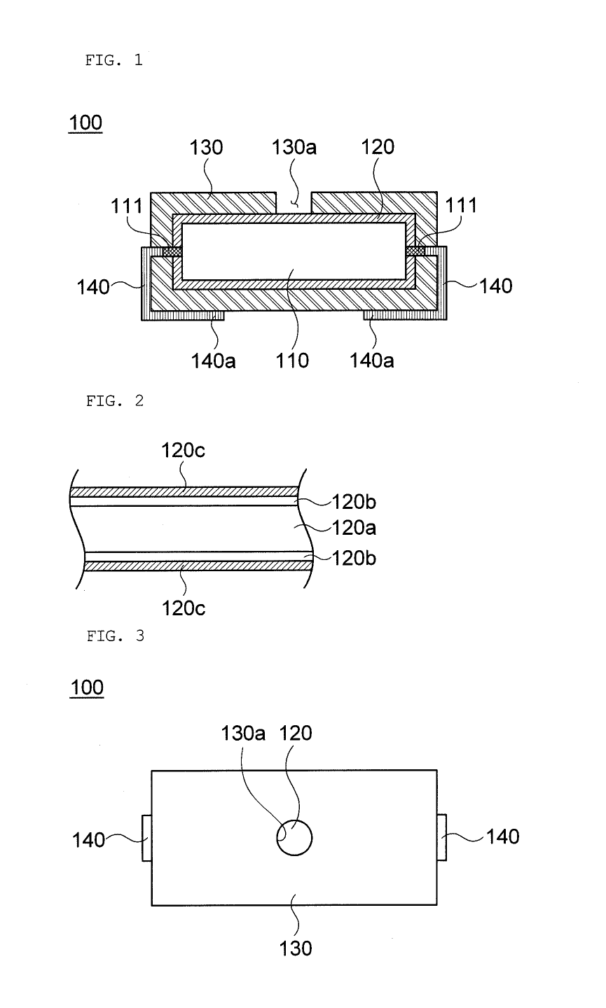

FIG. 2 is an enlarged cross-sectional view of a portion of a pouch cell included in the super capacitor according to the exemplary embodiment of the present invention. Referring to FIG. 2, the pouch cell 120 may be made of a laminate film configured of a metal thin plate 120a made of one material selected from, for example, iron (Fe), copper (Cu), aluminum (Al), stainless steel (SUS), nickel (Ni), tungsten (W), tin (Sn), and an alloy thereof, and the substance of the alloy and polymer resin layer 120c stacked on both surfaces of the metal thin plate 120a. Here, in order to increase strength of the pouch cell 120, the metal thin plate 120a may be provided in plural or have a thick thickness.

The polymer resin layer 120c is a layer for insulating between the metal thin plate 120a and the electrode assembly 110, and a material of the polymer resin layer 120c may be any one or at least two of polyethylene (PE), polypropylene (PP), nylon, and Teflon (PTFE). In addition, an adhesive resin 120b such as casting polypropylene (CPP) may be applied between the metal thin plate 120a and the polymer resin layer 120c.

A material of the resin case 130 molding the pouch cell 120 is not particularly limited as long as the resin has high strength and heat resistance. For example, the resin case 130 may be made of a thermosetting resin selected from a group consisting of an epoxy resin, a phenol resin, a urethane resin, a silicon resin, and a mixed resin thereof. In addition, a reinforcement material such as a glass fiber or an inorganic filler may be impregnated therein.

FIG. 3 is a plane view of a super capacitor 100 according to the exemplary embodiment of the present invention. In order to radiate heat generated in the electrode assembly 110 to the outside, the super capacitor according to the exemplary embodiment of the present invention may include a hole 130a formed in any one surface of the resin case 130 as shown in FIG. 3. A surface of the pouch cell 120 is partially exposed to the outside by the hole 130a, and as a result, the heat generated in the electrode assembly 110 is radiated to the outside by the hole 130a.

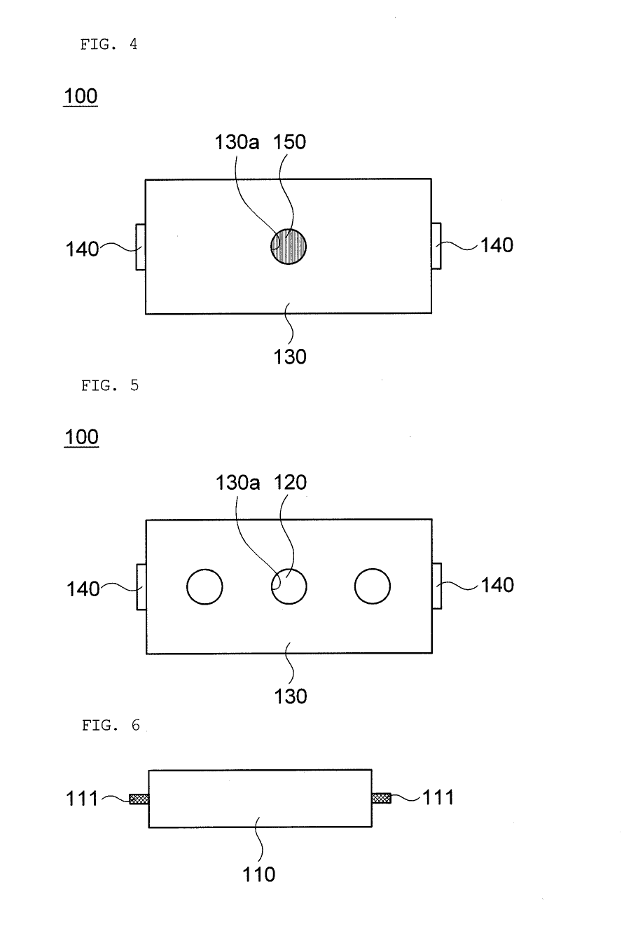

In order to further increase a heat radiation effect, as shown in FIG. 4, a metal material 150 having excellent thermal conductivity such as copper (Cu), gold (Au), silver (Ag), aluminum (Al), tungsten (W), or the like, may be filled in the hole 130a. Any material may be filled in the hole 130a instead of the metal material 150 as long as the material has excellent thermal conductivity.

The number of holes 130a as the heat radiation means as described above is not limited. Therefore, as shown in FIG. 5, three holes may be formed, and the hole may be formed in a front surface, a rear surface, and the like, as well as an upper surface of the resin case 130.

In addition, the larger the diameter of the hole 130a, the larger the heat radiation effect. However, since the strength of the resin case 130 may be reduced when the diameter is excessively large, it is preferable that the hole 130a has an appropriate diameter in consideration of the fact as described above.

Hereinafter, result values of comparing the super capacitor according to the present invention and the existing super capacitor with each other will be described. As test groups according to the present invention, an electric double layer capacitor (EDLC) in which active carbon electrode materials for an EDLC are used as a cathode and an anode and a tetraethylammonium tetrafluoroborate (TEABF)4/ACN electrolyte solution (1 M) is injected was used as Example 1, and a lithium ion capacitor (LIC) in which the an active carbon electrode material for an EDLC is used as a cathode, a graphite electrode material for an LIC is used as an anode, a lithium hexafluorophosphate (LiPF6)/(EC+PC+EMC) electrolyte solution (1.2 M) is injected was used as Example 2.

In addition, as the super capacitor according to the related art for comparing with Examples 1 and 2, an electric double layer capacitor (electrode materials and an electrolyte solution are the same as those in Example 1) enclosed by a general pouch cell 120 was used as Comparative Example 1, and a lithium ion capacitor (electrode materials and an electrolyte solution are the same as those in Example 2) enclosed by a general pouch cell 120 was used as Comparative Example 2. In this case, an active material layer used in Examples 1 and 2 and Comparative Examples 1 and 2 included an active material, an acetylene black (AB) conductive material, and a polyvinylidene fluoride (PVDF) binder at a mixing ratio of 80:10:10, and was cut at a size of 10 mm×8 mm to be stacked.

The following Table 1 shows initial properties of each of the Examples 1 and 2 and Comparative Examples 1 and 2 and properties thereof after high temperature acceleration tests (at 60° C. for 1000 hours) were performed at a voltage of 0.1 to 2.5 V on Example 1 and Comparative Example 1 and were performed at a voltage of 2.2 to 3.8 V on Example 2 and Comparative Example 2.

TABLE 1

| | | | | : Properties after high temperature | | |
|---|---|---|---|---|---|---|
| | | Initial properties | | acceleration test | | Capacitance (%) after high |
| | Classification | capacitance | Resistance | Capacitance | Resistance | temperature acceleration |
| EDLC | Example 1 | 0.178 F. | 1.97 Ω | 0.169 F. | 3.12 Ω | 95% |
| | Example 2 | 0.183 F. | 1.91 Ω | 0.149 F. | 4.51 Ω | 81% |
| LIC | Comparative Example 1 | 0.371 F. | 2.33 Ω | 0.337 F. | 3.98 Ω | 91% |
| | Comparative Example 2 | 0.382 F. | 2.27 Ω | 0.281 F. | 6.67 Ω | 74% |

Generally, the capacitance after the high temperature acceleration test based on the initial capacitance needs to be 80% or more, and the resistance based on the initial resistance needs to be within 200%, as cycle life characteristics of the super capacitor. As shown in Table 1, it may be appreciated that in the case of Examples 1 and 2 of the present invention, the capacitance (%) after high temperature acceleration test based on the initial capacitance was 95% and 91%, respectively, which were over the reference value, and the resistance value after the high temperature acceleration test based on the initial resistance were also within 200%.

On the other hand, it may be appreciated that in the case of Comparative Example 1, the capacitance (%) after the high temperature acceleration test based on the initial capacitance was 81%, which satisfied the reference value but the resistance value was more than 200%, and in the case of Comparative Example 2, both of the capacitance and resistance values after the high temperature acceleration test did not satisfy the reference values.

As described above, the super capacitor 100 according to the present invention has a structure in which the electrode assembly 110 sealed by the pouch cell 120 is molded again by the resin case 130, such that the super capacitor has rigidity against external impact, the electrolyte solution is not leaked, and a swelling phenomenon is not generated even though charging and discharging operations are repeatedly performed at a high temperature, thereby making it possible to significantly improve the cycle life characteristics of the super capacitor.

Hereinafter, a method of manufacturing a super capacitor according to the exemplary embodiment of the present invention will be described.

FIGS. 6 to 10 are process views sequentially showing a method of manufacturing a super capacitor according to the exemplary embodiment of the present invention. In the method of manufacturing a super capacitor according to the exemplary embodiment of the present invention, first, an electrode assembly 110 having electrode taps 111 protruding at both sides thereof is prepared as shown in FIG. 6.

The electrode assembly 110 is configured of at least one of an anode plate and a cathode plate that are alternately stacked, and a separator interposed between the anode plate and the cathode plate, and the electrode tap 111 is extended from each of the electrode plates to protrude from left and right side portions of the electrode assembly 110.

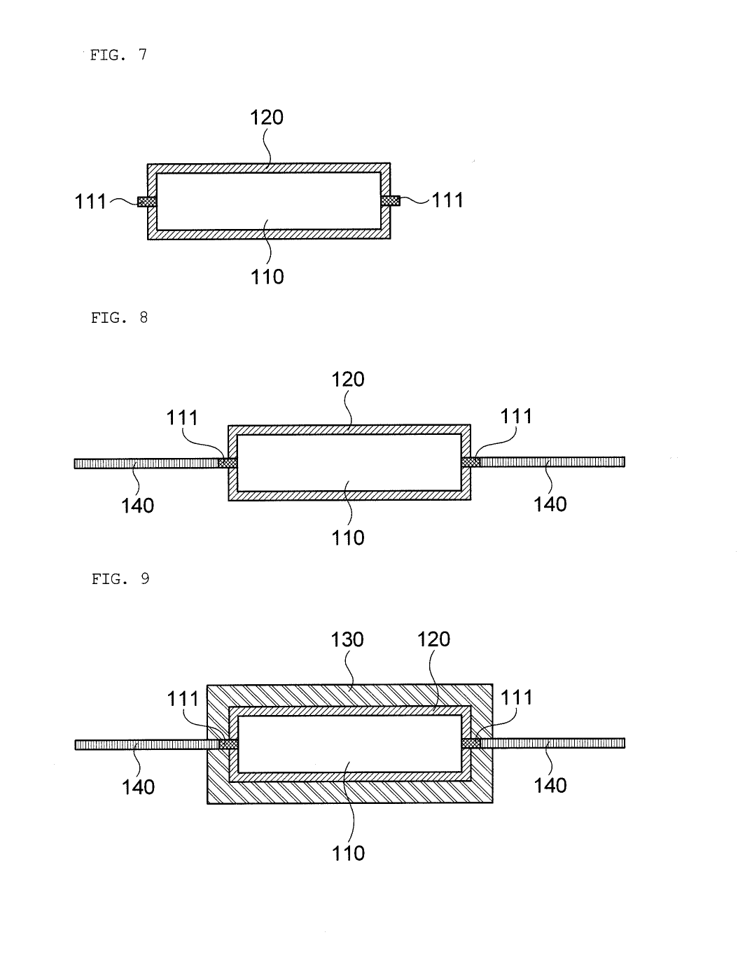

Next, as shown in FIG. 7, after a pouch cell 120 is formed on an outer peripheral surface of the electrode assembly 110 and an electrode solution (not shown in the drawings) is injected into the pouch cell 120, the pouch cell 120 is sealed.

Then, as shown in FIG. 8, the electrode tap 111 exposed to the outside of the pouch cell 120 is welded to one side of a lead wire 140. The welding may be performed by an electric spot welding method, an ultrasonic welding method, a laser welding method, or the like. Here, the lead wire 140 has a predetermined length or more so that a distal end thereof is bonded to a mounting surface of a resin case 130 formed in a subsequent process.

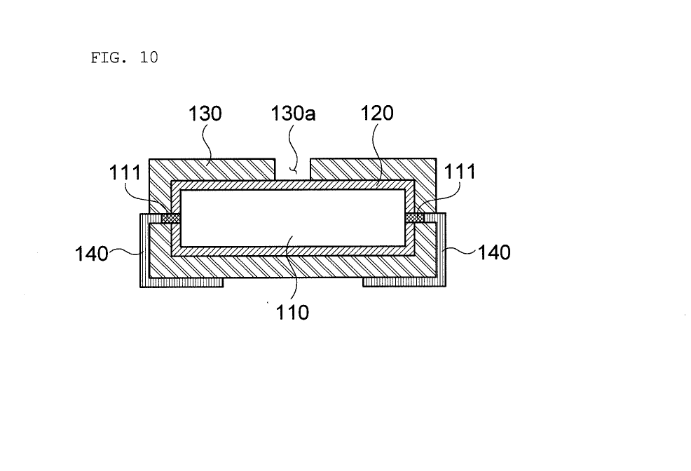

Next, as shown in FIG. 9, the pouch cell 120 is molded into the resin case 130.

The molding is performed by an injection molding method known in the art using slurry in which a thermosetting resin such as an epoxy resin, a phenol resin, a urethane resin, a silicon resin, or the like, is included as a main component, and a reinforcement material such as a glass fiber or an inorganic filer are mixed with the thermosetting resin. In this case, the other side of the lead wire 140 is exposed to the outside of the resin case 130.

Then, as shown in FIG. 10, the lead wire 140 exposed to the outside of the resin case 130 is appropriately bent along an outer peripheral surface of the resin case 130 to thereby be bonded to the outer peripheral surface of the resin case 130, thereby obtaining a super capacitor having a final shape.

Meanwhile, when the pouch cell 120 is molded into the resin case 130, a forming mold is designed so that a hole 130a is present in at least one surface of the resin case 130, such that a surface of the pouch cell 120 may be partially exposed to the outside through the hole 130a. Heat generated in the electrode assembly 110 may be radiated to the outside through the hole.

As another method of forming the hole 130a, the hole 130a may be directly formed in at least one surface of the resin case 130 entirely molding the pouch cell 120 as shown in FIG. 9.

Further, a metal material 150 having excellent thermal conductivity such as gold (Au), silver (Ag), aluminum (Al), tungsten (W), or the like, is filled in the hole 130a by a screen printing method, a sputtering method, an evaporation method, an inkjetting method, a dispensing method, or the like, thereby making it possible to further increase heat radiation effect.

According to the present invention, the super capacitor has rigidity against the external impact, the electrolyte solution is not leaked, and a swelling phenomenon is not generated even though charging and discharging operations are repeatedly performed at a high temperature, such that the cycle life characteristics of the super capacitor may be significantly improved.

The present invention has been described in connection with what is presently considered to be practical exemplary embodiments. Although the exemplary embodiments of the present invention have been described, the present invention may be also used in various other combinations, modifications, and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A super capacitor comprising:
an electrode assembly;
a pouch cell enclosing an outer peripheral surface of the electrode assembly;
a resin case molding the pouch cell; and
a lead wire of which one side is electrically connected to the electrode assembly and the other side exposed to the outside of the resin case is bonded to an outer peripheral surface of the resin case.

2. The super capacitor according to claim 1, wherein at least one surface of the resin case is provided with a hole, and a surface of the pouch cell is partially exposed to the outside through the hole.

3. The super capacitor according to claim 2, wherein a metal material is filled in the hole.

4. The super capacitor according to claim 2, wherein the number of holes formed in one surface of the resin case is one or more.

5. The super capacitor according to claim 1, wherein both sides of the electrode assembly are formed with electrode taps, and the electrode tap is exposed to the outside of the pouch cell to thereby be connected to the one side of the lead wire.

6. The super capacitor according to claim 1, wherein an electrode solution is interposed in the pouch cell.

7. The super capacitor according to claim 1, wherein a distal end of the lead wire exposed to the outside of the resin case is extended up to a mounting surface of the resin case.

8. The super capacitor according to claim 1, wherein the electrode assembly is configured of at least one of an anode plate and a cathode plate that are alternately stacked, and a separator interposed between the anode plate and the cathode plate.

9. The super capacitor according to claim 1, wherein the pouch cell is made of a laminate film configured of at least one metal thin plate and polymer resin layers stacked on both surfaces of the metal thin plate.

10. A method of manufacturing a super capacitor, the method comprising:
preparing an electrode assembly including electrode taps protruding at both sides thereof;
forming a pouch cell on an outer peripheral surface of the electrode assembly, injecting an electrode solution into the pouch cell, and then sealing the pouch cell;
welding the electrode tap exposed to the outside of the pouch cell to one side of a lead wire;
molding the pouch cell into a resin case; and
bending the lead wire exposed to the outside of the resin case along an outer peripheral surface of the resin case.

11. The method according to claim 10, wherein in the molding of the pouch cell into a resin case, a forming mold is designed so that a hole is present in at least one surface of the resin case to thereby partially expose a surface of the pouch cell to the outside through the hole.

12. The method according to claim 10, further comprising, after the molding of the pouch cell into a resin case, performing a hole forming process on at least one surface of the resin case to thereby partially expose a surface of the pouch cell to the outside through the hole.

13. The method according to claim 11, further comprising filling a metal material in the hole.

14. The method according to claim 12, further comprising filling a metal material in the hole.
